(19) United States
(12) Patent Application Publication
(10) Pub. No.: US 2022/0144373 A1
(43) Pub. Date: May 12, 2022

(54) ARRANGEMENT FOR A BICYCLE FRAME AND METHOD OF MANUFACTURE

(71) Applicant: POLE BICYCLE COMPANY OY, Muurame (FR)

(72) Inventor: Leo KOKKONEN, Jyväskylä (FI)

(21) Appl. No.: 17/602,546

(22) PCT Filed: Apr. 9, 2020
(86) PCT No.: PCT/EP2020/060119

§ 371 Date: Oct. 8, 2021

(30) Foreign Application Priority Data
Apr. 11, 2019 (FI) 20195295

(51) Int. Cl. B62K 19/02; B62K 19/18

(52) U.S. Cl. CPC B62K 19/02; B62K 19/18

(57) ABSTRACT

An arrangement for a bicycle frame including a housing for a member, the housing being connected to or a part of a first bicycle frame part, characterized in that the arrangement further includes a member at least partly insertable into the housing, the member being interlocked in place by another housing connected to or a part of a second bicycle frame part, wherein the housings are situated such that at least one of the housings is adjacent to a seam of the first and second bicycle frame parts adjoined together and further such that the member when inserted to the housings crosses transversally the adjacent seam. A bicycle frame and a corresponding method of manufacture are also presented.

### BACKGROUND OF THE INVENTION

### Field of the Invention

Generally, the present invention relates to vehicle frame structures and arrangements thereof. Particularly, however not exclusively, the present invention pertains to an arrangement for a bicycle frame and method of manufacture thereof.

### Description of the Related Art

Bicycle frames may be manufactured by adjoining two frame sides to each other. A big difficulty in this type of manufacturing is making the sides hold on to each other when the frame is put under a lot of different types of strains, such as when mountain bikes are driven in harsh terrains especially when the frame is used for hops and drops.

Such adjoining arrangements typically comprise using adhesives optionally with further mechanical fasteners such as screws through the adjoined sides. Such arrangements require typically further machining of the frame parts as well as additional complexity and number of components used for the frame. Further, screws and additional fasteners of the like add weight to a frame. Even further, external fasteners especially through the bicycle frame and pressing against the frame cause twisting, tensioning and points of force that may damage the frame and cause weak points to the frame.

In general, solutions for limiting lateral movement of the adjoined sides in relation to each other are difficult to machine. Attaching fasteners or mechanical structures with adhesives uniformly across two surface is also itself very difficult to do and hence not effective in practice.

Some prior art solutions have been discussed in past patent publications. For example, publication U.S. Pat. No. 5,464,240 A discloses a hollow shell frame for bicycles and other human powered vehicles, which frame is constructed from plastic molded partial shells that are assembled into tubing and which partial shells have protrusions and receptacles joining faces of their skins that are used to join the shells together to form the tube. Publication US 2009212530 AA discloses a unitary monocoque frame for a bicycle wherein a tongue and groove mating engagement is used to join two half shells forming the unitary monocoque frame. Publication U.S. Pat. No. 4,548,422 A discloses bicycle frame having a shell structure consisting of two assembled shells, which may be connected by gluing or rivets through the frame.

### SUMMARY OF THE INVENTION

The objective of the embodiments of the present invention is to at least alleviate one or more of the aforementioned drawbacks evident in the prior art arrangements particularly in the context of bicycle frame arrangements. The objective is generally achieved with an arrangement, bicycle frame and method in accordance with the present disclosure.

An advantage of the present invention is that it allows for strengthening of bicycle frames and frame parts thereof, which frames or frame parts are joined together. Frames and frame parts that are joined together comprise seams, which are prone to displacement in the longitudinal direction of the seam, i.e. movement of the parts in relation to each other. The present invention allows for additional strength for the whole frame or individual frame parts in the direction of the seam. Hence, the main purpose of the at least one housing and member in accordance with the present invention is to bear forces in the direction of the seams of the frame.

The present invention is especially beneficial in mountain and road bike frames, which consist of frame halves and/or other frame parts that are joined together, and which undergo different types of forces in various directions when used.

In accordance with one aspect of the present invention an arrangement for a bicycle frame comprising
a housing for a member, said housing being connected to or a part of a first bicycle frame part,
characterized in that the arrangement further comprises a member at least partly insertable into the housing, said member being interlocked in place by another housing connected to or a part of a second bicycle frame part,

wherein the housings are situated such that at least one of the housings is adjacent to a seam of the first and second bicycle frame parts adjoined together and further such that the member when inserted to the at least one housings crosses transversally said adjacent seam.

According to an exemplary embodiment of the present invention at least one of the housings is situated physically adjacent to a seam.

According to an exemplary embodiment of the present invention the cross-section of the housings and the member are circular.

According to an exemplary embodiment of the present invention the housing and the member are ball-like.

According to an exemplary embodiment of the present invention at least one of the housings is inside the first and/or second frame part.

According to an exemplary embodiment of the present invention at least one of the housings is formed to the inner surface of the first or second frame part.

According to an exemplary embodiment of the present invention the member is formed or connected to another bicycle frame part and coincident to the first housing when the bicycle frame parts are joined at the seam.

According to an exemplary embodiment of the present invention the member is formed or connected to the inner surface of the first and/or second frame part.

In accordance with one aspect of the present invention a bicycle frame comprising a plurality of arrangements as disclosed and claimed.

In accordance with one aspect of the present invention a manufacture for a bicycle frame comprising
producing a first housing adjacent and transversal to a seam of a first bicycle frame part,
producing a member insertable at least partly into said housing,
producing another housing to a second bicycle frame coincident to the other housing when the first and second bicycle frame parts are joined at a seam and wherein member may be inserted inside the housings,
characterized in that the housings are produced at such situations that at least one of the housings is adjacent to a seam of the first and second bicycle frame parts when adjoined together and further such that the member when inserted to the at least one housing crosses transversally said adjacent seam and wherein member is interlocked in place by the housings.

The arrangement in accordance with present invention may be used in bicycle frames of various materials at seams wherein further reinforcement is needed to counter forces along and in the (longitudinal) direction of the seam. For example, when two sides of a front frame of a bicycle are joined together at seams e.g. by gluing the seam forms a structural weakness in the bicycle frame in comparison to the adjacent stiff uniform frame material, which seam is hence prone to lateral movement in the longitudinal direction of the seam and or failure due to sudden forces exerted to the bicycle frame while riding. The member interlocked in the at least one housing in accordance with the present invention counter forces at and in direction of the seams so that the first and second frame parts are prevented from moving laterally in relation to each other.

As briefly reviewed hereinbefore, the utility of the different aspects of the present invention arises from a plurality of issues depending on each particular embodiment.

The expression “bicycle” is herein used to refer to various wheel-based vehicles for a number of users, which may be manually or motor-powered or a combination of the aforementioned, and it is meant to encompass also unicycles, tricycles quadracycles, and the like. In a broader sense, the expression may be also seen as to encompass motorbikes.

The expression “member” is herein used to refer to a part that is inserted into the housing, and which has at least a solid outer edge but which may be hollow or solid inside and encompass various different cross-sectional and other shapes and various different widths (both external and internal).

The expression “a number of” may herein refer to any positive integer starting from one (1). The expression “a plurality of” may refer to any positive integer starting from two (2), respectively.

The term “exemplary” refers herein to an example or example-like feature, not the sole or only preferable option.

Different embodiments of the present invention are also disclosed and claimed.

### BRIEF DESCRIPTION OF THE DRAWINGS

Some exemplary embodiments of the present invention are reviewed more closely with reference to the attached drawings, wherein

FIG. 1 depicts a cutaway view of an embodiment of the arrangement in accordance with the present invention,

FIG. 2 depicts a cutaway view of an embodiment of the arrangement in accordance with the present invention,

FIG. 3 depicts a general cutaway view of an embodiment of the arrangement in accordance with the present invention,

FIG. 4 depicts a cross-sectional cutaway view of an embodiment of the arrangement in accordance with the present invention,

FIG. 5 depicts a partial cutaway view of an embodiment of the arrangement in accordance with the present invention,

FIG. 6 depicts a cross-sectional cutaway view of an embodiment of the arrangement in accordance with the present invention,

FIG. 7 depicts a flow diagram illustrating an embodiment of the method in accordance with the present invention.

### DETAILED DESCRIPTION OF THE EMBODIMENTS

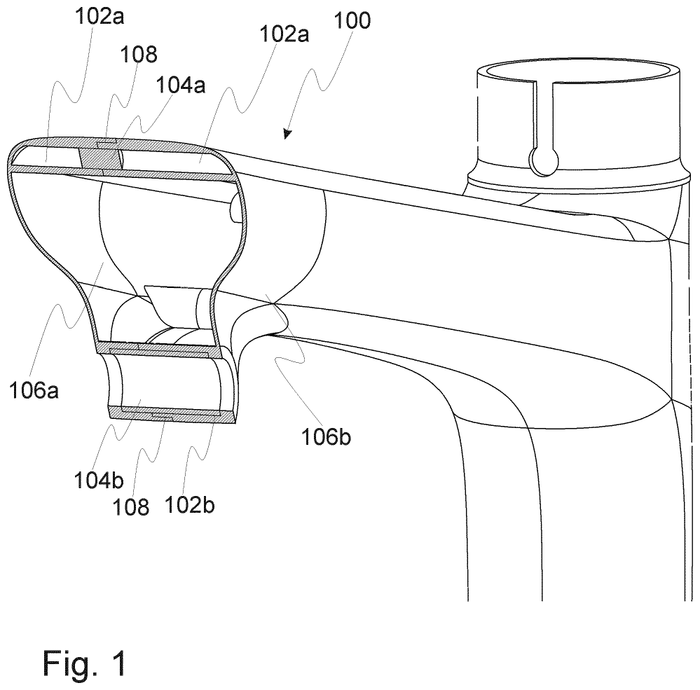

FIG. 1 depicts a cutaway view of an embodiment of the arrangement (100) in accordance with the present invention.

The arrangement (100) comprises at least one housing (102a, 102b) formed in or to a first and/or second frame part (106a, 106b) and a member (104a, 104b) at least partly insertable into the housing (102a, 102b), which at least one housing (102a, 102b) and member (104a, 104b) are situated at and adjacent to a seam (108) and transversally positioned in relation to the longitudinal direction of the seam (108). The seam (108) is formed by the connection of a first frame part (106a) and a second frame part (106b) connected to each other. The at least one housing (102a, 102b) and member (104a, 104b) may be different in size and shape but their function is to withstand forces in the longitudinal direction of the seam (108).

In this view of the embodiment a first housing (102a) comprises a protrusion from the frame (106a, 106b), which may be manufactured as part of the frame parts (106a, 106b) or attached thereto. A first housing (102a) is formed to the first and second frame parts (106a, 106b) coincidentally such that they are cross-sectionally aligned when the two frame parts (106a, 106b) are joined together. A first member (104a), which in this embodiment cylindrical and solid, is situated in the first housing (102a) adjacent to a part of the seam (108) and interlocked by the coincident first housings (102a) or by the connection to a frame part (106a, 106b) inner wall and insertion into the first housing (102a). The function of the at least one first housing (102a) and first member (104a) is to reinforce the frame. The first member (104a) of this kind may be a dowel, pin, rod, or the like.

As depicted, the first housing (102a) and the first member (104a) are preferably situated inside the bicycle frame when the frame parts (106a, 106b) are joined. The first housing (102a) and the first member (104a) are preferably connected to the inner surface or manufactured to be a part of the frame parts (106a, 106b) inner walls. However, the first member (104) may also be not connected to the inner surface or manufactured to be a part of the frame parts (106a, 106b) inner walls but be inserted into the coincident two first housings (102a) before the frame parts (106a, 106b) are adjoined. A second housing (102b) is formed as a cylindrical recess or cutaway to at least one of the first and second frame parts (106a, 106b), which may be manufactured as part of the frame parts (106a, 106b). One second housing (102b) may be formed to each frame part (106a, 106b) coincidentally such that they are cross-sectionally aligned when the two frame parts (106a, 106b) are joined together. A second member (104b), which in this embodiment cylindrical with a thin wall thickness and hollow middle, is situated in the second housing (102b) adjacent to a part of the seam (108) and interlocked by the coincident second housings (102b) or by the connection to or as part of a one frame part (106a, 106b) and insertion into the second housing (102b) at another frame part (106a, 106b). The function of the at least one second housing (102b) and second member (104b) therein is to reinforce the frame and provide a housing and connection point for a shock absorber.

The second housing (102b) comprises a shape which allows the member (104b) to be fitted therein before joining the frame parts (106a, 106b) but which second housing (102b) physically stops the second member (104b) from moving out of the second housing (102b). Due to the geometry of the second housing (102b) and the second member (104b) the second member (104b) cannot be moved out from the second housing (104b) after joining the frame parts (106a, 106b) without moving or breaking at least one of the frame parts (106a, 106b). The second member (104b) of this kind may be a ring, socket, bearing housing, or the like.

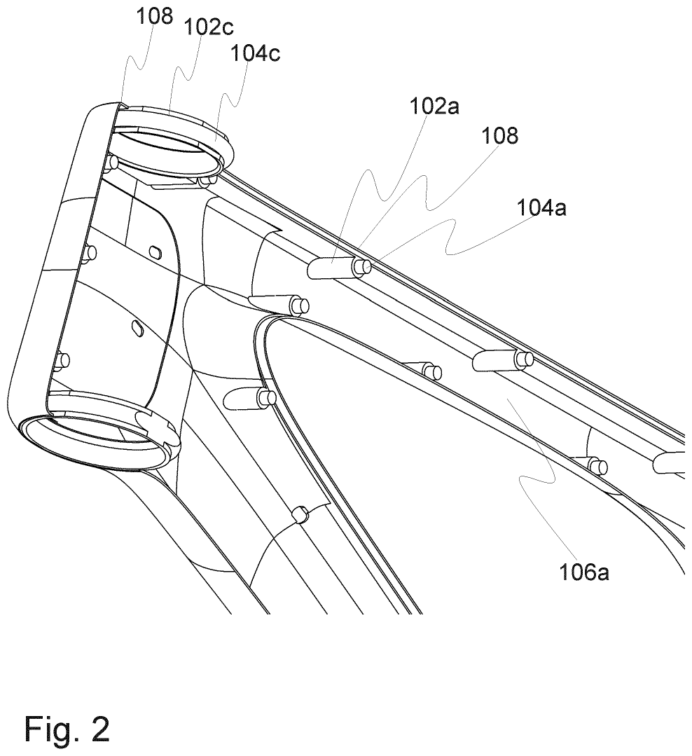

FIG. 2 depicts a cutaway view of an embodiment of the arrangement (100) in accordance with the present invention.

In this view, a third housing (102c) is formed as a half-circle like recess or cutaway to the frame parts (106a, 106b), which may be manufactured as part of the frame parts (106a, 106b). One third housing (102c) is formed to each frame part (106a, 106b) coincidentally such that they are cross-sectionally aligned when the two frame part (106a, 106b) are joined together. A third member (104c), which in this embodiment ring-like, is situated in the third housing (102c) adjacent to a part of the seam (108). The function of the third housing (102b) and third member (104b) therein is to reinforce the frame and provide a housing for the front fork and/or headset thereof. The third member (104c) of this kind may be a ring, socket, bearing housing, or the like.

A plurality of first housings (102a) and first members (104a) thereof are also depicted although only one is numbered as an example for reference.

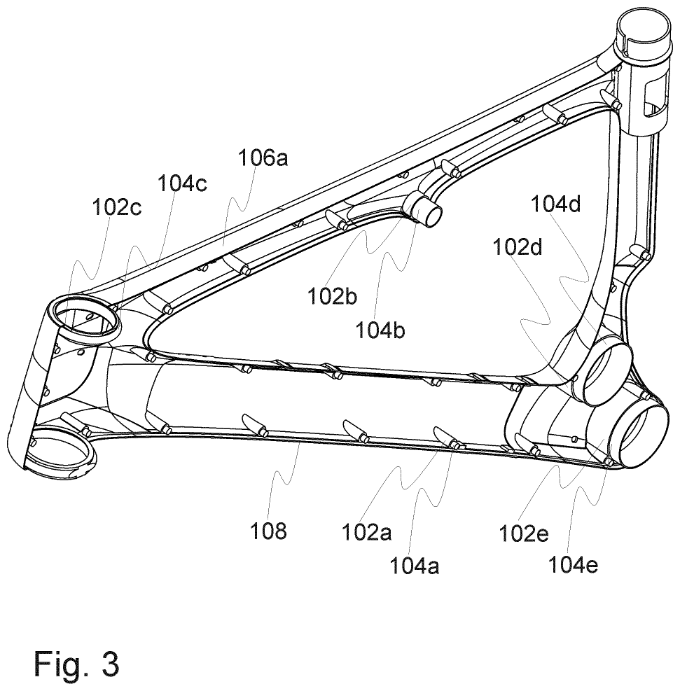

FIG. 3 depicts a general cutaway view of an embodiment of the arrangement (100) in accordance with the present invention.

A fourth housing (102d) is formed as a cylindrical recess or cutaway to at least one of the first and second frame parts (106a, 106b), which may be manufactured as part of the frame parts (106a, 106b). One fourth housing (102d) may be formed to each frame part (106a, 106b) coincidentally such that they are cross-sectionally aligned when the two frame parts (106a, 106b) are joined together. A fourth member (104d), which in this embodiment cylindrical with a thin wall thickness and hollow middle, is situated in the fourth housing (102d) adjacent to a part of the seam (108) and interlocked by the coincident fourth housings (102d) or by the connection to or as part of a one frame part (106a, 106b) and insertion into the fourth housing (102d) at another frame part (106a, 106b). The function of the at least one fourth housing (102d) and fourth member (104d) therein is to reinforce the frame and to provide a connection point for a rear frame, such as a link system connection. The fourth member (104d) of this kind may be a ring, socket, bearing housing, or the like.

A fifth housing (102e) is formed as a cylindrical recess or cutaway to at least one of the frame parts (106a, 106b), which may be manufactured as part of the frame parts (106a, 106b). One fifth housing (102e) may be formed to each frame part (106a, 106b) coincidentally such that they are cross-sectionally aligned when the two frame parts (106a, 106b) are joined together. A fifth member (104e), which in this embodiment cylindrical with a thin wall thickness and hollow middle, is situated in the fifth housing (102e) adjacent to a part of the seam (108) and interlocked by the coincident fifth housings (102e) or by the connection to or as part of a one frame part (106a, 106b) and insertion into the fifth housing (102e) at another frame part (106a, 106b). The function of the fifth housing (102e) and fifth member (104e) therein is to reinforce the frame and to provide a housing from a bottom bracket. The fifth member (104e) of this kind may be a ring, socket, bearing housing, or the like.

Similarly to the second housing (102b) and second member (104b) the fourth and fifth housings (102d, 102e) and members (104d, 104e) are preferably arranged such that the fourth member (104d) and fifth member (104e) may not move out from their corresponding housings (102d, 102e) after joining the frame parts (106a, 106b) without moving or breaking at least one of the frame parts (106a, 106b).

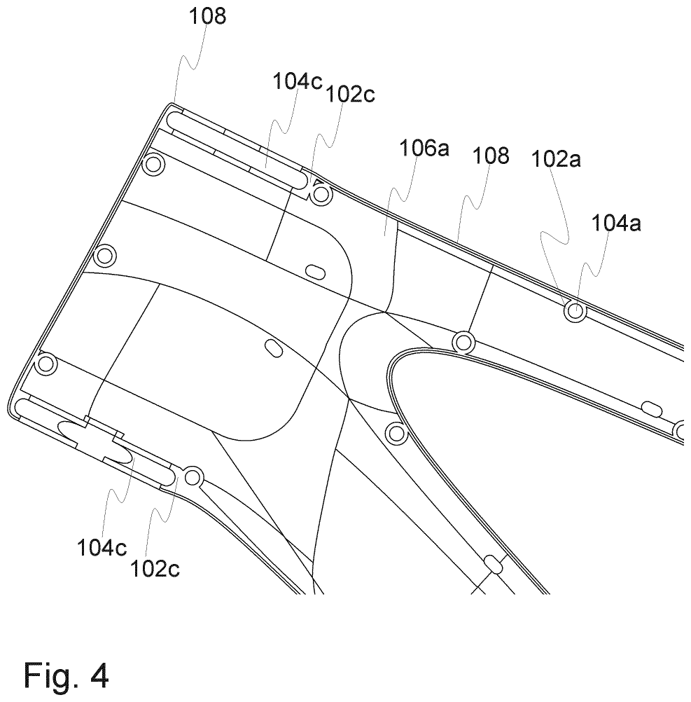

FIG. 4 depicts a cross-sectional cutaway view of an embodiment of the arrangement (100) in accordance with the present invention. In this view plurality of first housings (102a) and first members (104a) thereof are depicted with two third housings (102c) and third members (104c) thereof.

The first members (104a) and first housings (102a) may comprise various different shapes, such as cross-sectionally circular, elliptical, square-like or the like. The first members (104a) may be solid or partly hollow. As an example a first housing (102a) could have a wall thickness of 1-1.5 mm wherein the inner diameter for the first member (104a) could be 5 mm wherein the first member (104a) would preferably then have a corresponding outer diameter. The first members (104a) are preferably inserted into the first housings (102a) with adhesive, such as glue. The first members (104a) may comprise a number of holes or grooves for easier insertion to the first housings (102a).

The first housings (102a) and first members (104a) may take a size in accordance with the preferred strength properties and design goals. Similarly, the number of the first housings (102a) and first members (104a) in a bicycle frame along the seam (108) may vary in accordance with the preferred strength properties of the bicycle frame.

The first housing (102a) needn't surround the whole circumference of a first member (104a) and it is sufficient that the first housing (102a) holds a first member (104a) in place so that the first member (104a) cannot come out of the first housing (102a) after joining the frame parts (106a, 106b) without moving or breaking the frame parts (106a, 106b).

Although not explicitly depicted, the first housing (102a) may comprise a threaded hole and a first member (104a) may comprise a corresponding threading that fits into the threaded hole.

The first housing (102a) and the first member (104a) may be arranged such that the first housing (102a) is connected to the other frame part (106a) and the first member is connected to the other frame part (106b) without another coincidental first housing in the other frame part (106b). In another embodiment, both of the frame parts (106a, 106b) may comprise a first housing (102a) coincidental to each other when the frame parts (106a, 106b) are joined at the seam (108) wherein the first member (104a) is inserted into either of the coincidental first housings (102a) before joining the frame parts (106a, 106b) and wherein the first member (104a) needn't hence be directly connected to either of the frame part (106a, 106b) inner walls but at least locked in the coincidental first housings (102a).

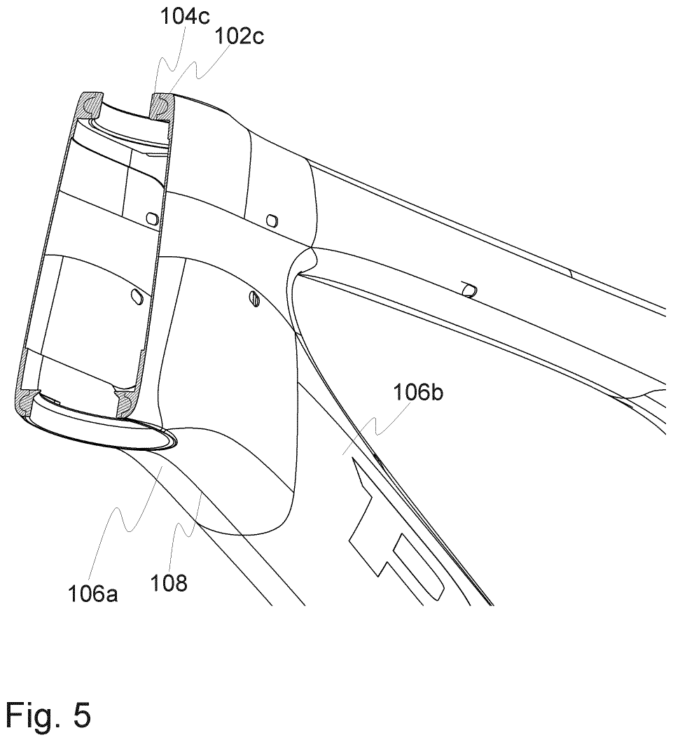

FIG. 5 depicts a partial cutaway view of an embodiment of the arrangement (100) in accordance with the present invention. In this view two third housings (102c) and third members (104c) thereof are depicted with the frame parts (106a, 106b) connected together at the seam (108).

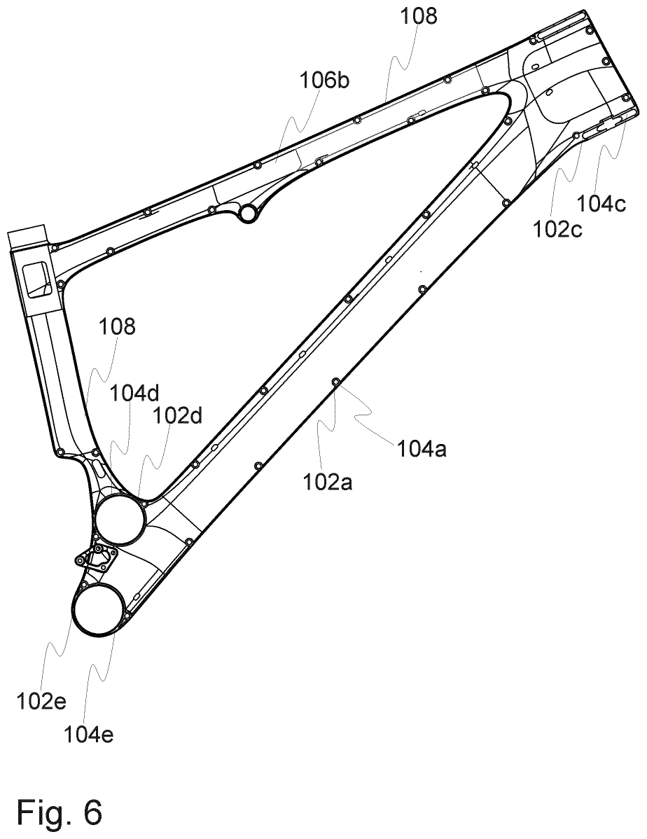

FIG. 6 depicts a cross-sectional cutaway view of an embodiment of the arrangement (100) in accordance with the present invention. A plurality of housings and members along a seam (108) line on a frame part (106b) to which another frame part (106a) may be connected to form the front frame of a bicycle. The frame parts (106a, 106b) may be connected to each other by gluing at the seam (108) for example.

All the depicted housings (102a, 102b, 102c, 102d, 102e) and members thereof (104a, 104b, 104c, 104d, 104e) are situated such that they are transversal in in relation to the direction of the seam (108) and such that each housing (102a, 102b, 102c, 102d, 102e) locks their corresponding members (104a, 104b, 104c, 104d, 104e) in place and counterforce strengths especially in the longitudinal direction of the seam (108).

The bicycle frame part (106a, 106b) material may comprise e.g. carbon fibre or other such suitable composites, as well as aluminum, steel or various known alloys. Same materials may be used for the housings (102a, 102b, 102c, 102d, 102e) and members (104a, 104b, 104c, 104d, 104e). The frame part (106a, 106b) materials and adjacent housing (102a, 102b, 102c, 102d, 102e) and member (104a, 104b, 104c, 104d, 104e) materials are preferably chosen such that the connected materials do not form a galvanic couple.

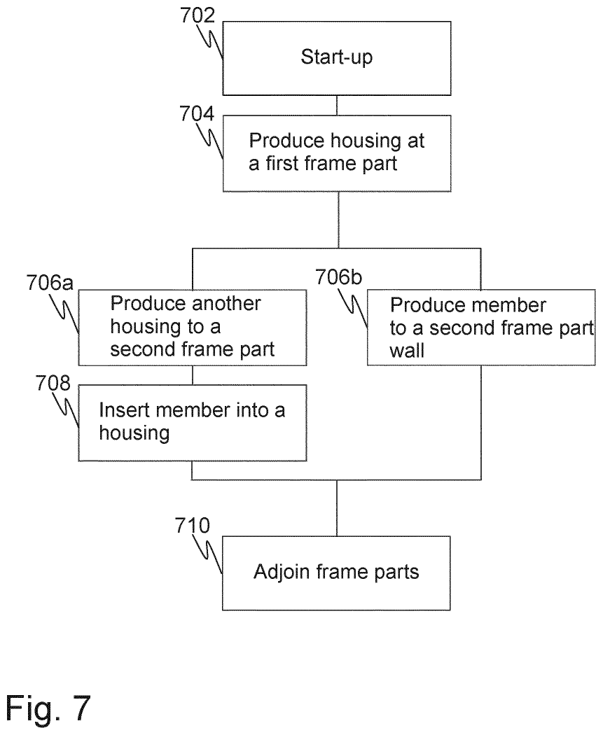

FIG. 7 depicts a flow diagram illustrating an embodiment of the method in accordance with the present invention.

At 702, pertaining to a start-up of the method, the design options including the placement, amount, size and shape of the housings and members in bicycle frame to be manufactured may be made. The frame parts may be prefabricated or manufactured in light of the housing and member arrangement.

At 704, a housing is produced to a first frame part adjacent to a first frame part edge whereby the first frame part will be joined to a second frame part. The housing may be connected or manufactured directly on to the first frame part. The housing may also be made by cutting material from the first frame part. The housing may be also made by together with first frame part, such as that the housing is an integral part of the first frame part.

At 706a, another housing is manufactured to a second frame part at a location which is coincidental to the housing produced at 704 when the first frame part and second frame part are aligned for joining. The housing may be connected or manufactured directly on to the second frame part. The housing may also be made by cutting material from the second frame part. The housing may be also made by together with second frame part, such as that the housing is an integral part of the second frame part.

At 706b, optionally another housing is not manufactured to a second frame part but the member is manufactured to a second frame part. The member may be connected or manufactured directly on to the second frame part. The member may be also made by together with frame part, such as that the member is an integral part of the second frame part.

At 708, member is inserted into a housing using adhesives.

At 710, the first and second frame parts are connected at a seam e.g. by an adhesive. The first and second frame parts are joined such that the member is inserted to the one or two coincident housings. The member may be fastened to the one or two housings by adhesives.

The scope of the invention is determined by the attached claims together with the equivalents thereof. The skilled persons will again appreciate the fact that the disclosed embodiments were constructed for illustrative purposes only, and the innovative fulcrum reviewed herein will cover further embodiments, embodiment combinations, variations and equivalents that better suit each particular use case of the invention.

1. An arrangement for a bicycle frame comprising:
a housing for a member, said housing being connected to or a part of a first bicycle frame part,
wherein the arrangement further comprises a member at least partly insertable into the housing, said member being interlocked in place by another housing connected to or a part of a second bicycle frame part,
wherein the housings are situated such that at least one of the housings is adjacent to a seam of the first and second bicycle frame parts adjoined together and further such that the member when inserted to the housings crosses transversally said adjacent seam.

2. The arrangement for a bicycle frame of claim 1, wherein at least one of the housings is situated physically adjacent to the seam.

3. The arrangement for a bicycle frame of claim 1, wherein the cross-section of the housings and the member are circular.

4. The arrangement for a bicycle frame of claim 1, wherein the housings and the member are ball-like.

5. The arrangement for a bicycle frame of claim 1, wherein at least one of the housings is inside first and/or second frame part.

6. The arrangement for a bicycle frame of claim 1, wherein at least one of the housings is formed to the inner surface of the first or second frame part.

7. The arrangement for a bicycle frame of claim 1, wherein the member is formed or connected to another bicycle frame part and coincident to the first housing when the bicycle frame parts are joined at the seam.

8. The arrangement for a bicycle frame of claim 1, wherein the member is formed or connected to the inner surface of the first and/or second frame part.

9. A bicycle frame comprising a plurality of arrangements in accordance with claim 1.

10. A method of manufacture for a bicycle frame comprising
producing a housing adjacent and transversal to a seam of a first bicycle frame part,
producing a member insertable at least partly into said housing,
producing another housing to a second bicycle frame coincident to the other housing when the first and second bicycle frame parts are joined at a seam and wherein member may be inserted inside the housings,
wherein the housings are produced at such situations that at least one of the housings is adjacent to a seam of the first and second bicycle frame parts when adjoined together and further such that the member when inserted to the at least one housing crosses transversally said adjacent seam and wherein member is interlocked in place by the housings.

11. The arrangement for a bicycle frame of claim 2, wherein the cross-section of the housings and the member are circular.

12. The arrangement for a bicycle frame of claim 2, wherein the housings and the member are ball-like.

13. The arrangement for a bicycle frame of claim 3, wherein the housings and the member are ball-like.

14. The arrangement for a bicycle frame of claim 2, wherein at least one of the housings is inside first and/or second frame part.

15. The arrangement for a bicycle frame of claim 3, wherein at least one of the housings is inside first and/or second frame part.

16. The arrangement for a bicycle frame of claim 4, wherein at least one of the housings is inside first and/or second frame part.

17. The arrangement for a bicycle frame of claim 2, wherein at least one of the housings is formed to the inner surface of the first or second frame part.

18. The arrangement for a bicycle frame of claim 3, wherein at least one of the housings is formed to the inner surface of the first or second frame part.

19. The arrangement for a bicycle frame of claim 4, wherein at least one of the housings is formed to the inner surface of the first or second frame part.

20. The arrangement for a bicycle frame of claim 5, wherein at least one of the housings is formed to the inner surface of the first or second frame part.
